(19) United States
(12) Patent Application Publication
(10) Pub. No.: US 2020/0019509 A1
(43) Pub. Date: Jan. 16, 2020

(54) DATA STORAGE DEVICE AND OPERATION METHOD USING THE SAME

(71) Applicant: MACRONIX INTERNATIONAL CO., LTD., Hsinchu (TW)

(72) Inventor: Tzu-Yi YANG, Hsinchu City (TW)

(21) Appl. No.: 16/034,694

(22) Filed: Jul. 13, 2018

(51) Int. Cl. G06F 12/1009

(52) U.S. Cl. CPC G06F 12/1009; G06F 2212/202; G06F 2212/1008

(57) ABSTRACT

A data storage device comprises a memory and a memory controller. The memory comprises a plurality of pages. Each of the pages comprises a physical address. The memory controller is coupled to the memory. The memory controller is configured to perform following operation: receiving a plurality of data; writing the plurality of data into a plurality of first pages of the memory; verifying the plurality of data stored in the first pages of the memory; writing the data which do not pass the verification into one or more second pages of the memory; and establishing one or more mapping tables according to the physical address(es) of the first page(s) corresponding to the data which do not pass the verification and the physical address(es) of the second page(s).

### BACKGROUND OF THE INVENTION

### Field of the Invention

The invention relates to a data storage device and operation method using the same.

### Description of the Related Art

In recent years, memories play an important role in people's lives. Among various types of memory, read only memory (ROM) such as one time programmable (OTP) memory or quad-level cells (QLC) memory is a type of memory that can only be read after being programmed in use. Since chips of a ROM may have defects at different positions, it is necessary to manage the defective positions of a ROM based on consideration of data reliability.

### SUMMARY OF THE INVENTION

A data storage device is disclosed in an embodiment of the present invention. The data storage device comprises a memory and a memory controller. The memory comprises a plurality of pages. Each of the pages comprises a physical address. The memory controller is coupled to the memory. The memory controller is configured to perform following operation: receiving a plurality of data; writing the plurality of data into a plurality of first pages of the memory; verifying the plurality of data stored in the first pages of the memory; writing the data which do not pass the verification into one or more second pages of the memory; and establishing one or more mapping tables according to the physical address(es) of the first page(s) corresponding to the data which do not pass the verification and the physical address(es) of the second page(s).

An operation method using data storage device is disclosed in another embodiment of the present invention. The data storage device comprises a memory and a memory controller. The operation method is performed by the memory controller. The operation method comprises: receiving, by the memory controller, a plurality of data; writing, by the memory controller, the plurality of data into a plurality of first pages of the memory; verifying, by the memory controller, the plurality of data stored in the first pages of the memory; writing, by the memory controller, the data which do not pass the verification into one or more second pages of the memory; and establishing, by the memory controller, one or more mapping tables according to the physical address(es) of the first page(s) corresponding to the data which do not pass the verification and the physical address(es) of the second page(s).

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram of a data storage device according to an embodiment of the present invention.

FIGS. 2A and 2B show flowcharts of operation method using data storage device according to an embodiment of the present invention.

FIG. 3 shows an example of memory according to the present invention.

FIG. 4 shows an example of mapping table according to the present invention.

FIGS. 5 and 6 show examples of searching the target logical address in the mapping table according to the present invention.

FIG. 7 shows an example of an index and mapping tables according to the present invention.

### DETAILED DESCRIPTION OF THE INVENTION

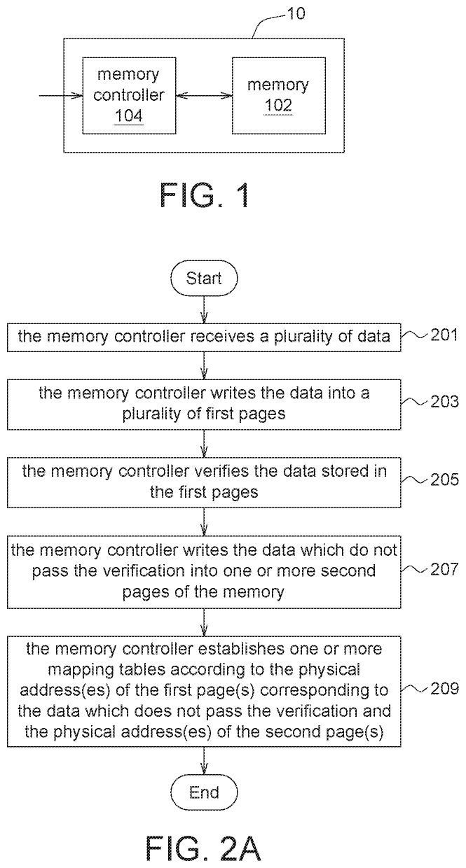

Referring to FIG. 1, FIG. 1 shows a block diagram of data storage device according to the present invention. The data storage device 10 includes a memory 102 and a memory controller 104.

The memory 102 may include one or more chips. Each of the chips may include a number of planes. Each of the planes may include a number of blocks. Each of the blocks may include a number of pages. Each of the pages may include a number of cells. In an embodiment, each of the pages may have a physical address.

In the embodiment, the memory 102 may be a non-volatile memory such as a NAND flash memory, a NOR flash memory or a phase change memory. The memory 102 may be read only after being programmed in use. That is, the memory 102 is a read only memory (ROM). For example, the memory 102 may be a one-time programmable (OTP) memory or a quad-level cells (QLC) memory.

The memory controller 104 is coupled to the memory 102. The memory controller 104 may be implemented by one or more chips including hardware, firmware, software or combination of the above that can perform operation method provided by the present invention. The memory controller 104 may be further coupled to a host device (not shown), and receives operation commands such as write command, read command and erase command from the host device. In response to operation commands, the memory controller 104 may perform operations corresponding to the received operation commands.

In general, unpredictable defects may be produced on some of the cells of the memory 102 during the manufacturing process. Data stored in the defective cells or areas may be weak or incorrect, thereby leads to a decrease in reliability. To solve the above problem, the memory controller 104 is configured to perform the operation method provided by the present invention, as described below.

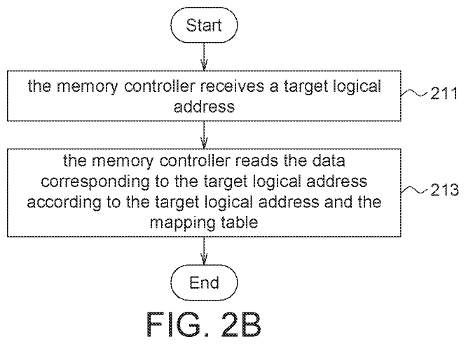

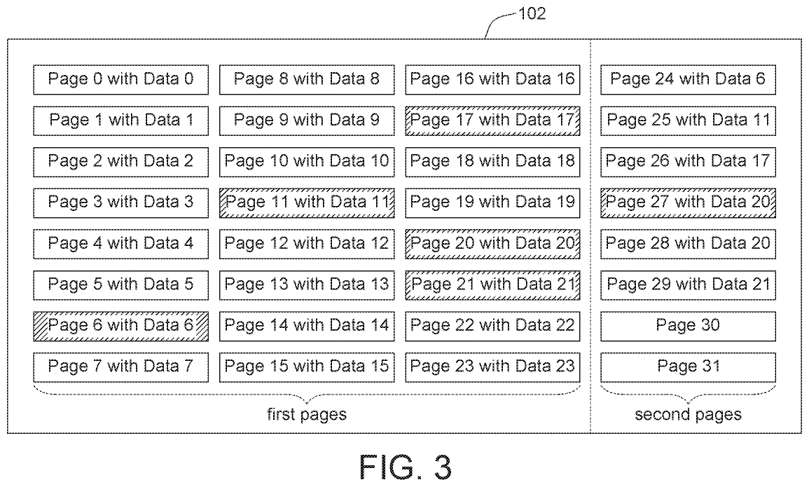

Referring to FIGS. 2A and 2B, FIGS. 2A and 2B show flowcharts of operation method using data storage device according to the present invention. The method of operation can be divided into two parts, including programming operation and reading operation. The programming operation may be illustrated firstly with referring to FIG. 2A, and the reading operation may be illustrated secondly with referring to FIG. 2B. In this embodiment, the memory 102 is an OTP memory. That is, the memory 102 may be read only after being programmed once. For understanding, please also refer to FIG. 3 which illustrates a scheme diagram of memory with a number of pages according to an embodiment of the present invention.

In step 201, the memory controller 104 receives a plurality of data, for example, from the host device. The memory controller 104 may also receive a start address. The start address indicates an address of the memory 102 that the data to be written from.

In step 203, the memory controller 104 writes the data into a plurality of first pages, for example, according to the start address. As the example shown in FIG. 3, the data to be written is a sequence of data from data 0 to data 23, and data 0˜data 23 are written into the memory 102 from the start address (i.e., page 0) to page 23. For example, data 0 is written into page 0, data 1 is written into page 1, and so forth. That is, the first pages in this example are page 0˜page 23. It should be noted that, page 0˜page 31 represents the physical addresses of the corresponding pages, and the memory 102 has defects at pages 6, 11, 20, 21 and 27.

In step 205, the memory controller 104 verifies the data stored in the first pages. More specifically, the host device may send the same data (i.e., data 0˜data 23) again to the memory controller 104. The memory controller 104 may compare the data stored in the first pages with the received data to perform a verification. Since the memory 102 has defects at pages 6, 11, 17, 20, 21 and 27, the memory controller 104 may determine that the data 6, 11, 17, 20 and 21 stored in the pages 6, 11, 17, 20 do not pass the verification.

In step 207, the memory controller 104 writes the data which do not pass the verification into one or more second pages of the memory 102. In this example, data 6, 11 and 17 are written into pages 24, 25 and 26. For data 20, since memory 102 has defects at page 27, data 20 is further “moved” from page 27 to page 28, and then data 21 is written into page 29. In other words, data 6, 11, 17, 20 and 21 can be seen as being “moved” from the corresponding first pages (pages 6, 11, 17, 20 and 21) to the second pages (pages 24, 25 26, 28 and 29).

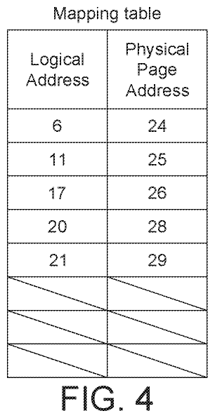

In step 209, the memory controller 104 establishes one or more mapping tables according to the physical address(es) of the first page(s) corresponding to the data which do not pass the verification and the physical address(es) of the second page(s). Based on the example shown in FIG. 3, the mapping table established by the memory controller 104 is shown in FIG. 4. In the mapping table, “Logical address” indicates addresses sent by the host device, and “physical address” indicates the actual address of which the data are stored in. For example, the data stored in logical address 6 (data 6) is actually stored in physical address 24 (page 24). That is, the mapping table records a map of logical address to physical address of the data stored in the memory 102. More specifically, the mapping table only records the addresses of the data which have been “moved” since the original addresses (e.g., the first pages) are defective.

Referring to FIG. 2B, reading operation of the operation method is illustrated.

In step 211, the memory controller 104 receives a target logical address, for example, from the host device for reading a target data.

In step 213, the memory controller 104 reads the data corresponding to the target logical address according to the target logical address and the mapping table(s). In an embodiment, the memory controller 104 firstly determines whether the target logical address is in the mapping table(s). If the target logical address isn't in the mapping table, the memory controller 104 may determine that the actual physical address of the target data is equivalent to the target logical address. For example, it is assumed that the memory controller 104 receives a target logical address of page 19. Since the memory controller 104 can't find page 19 in the column of logical address of the mapping table, the memory controller 104 may read physical address 19 (page 19) for the target data. If the target logical address is in the mapping table, the memory controller 104 may read the target data from the physical address corresponding to the target logical address according to the mapping table. For example, it is assumed that the memory controller 104 receives a target logical address of page 20. Since the memory controller 104 can find page 20 in the column of logical address of the mapping table, the memory controller 104 may read physical address 28 (page 28) which is corresponding to logical address 20 (page 20) in the mapping table for the target data.

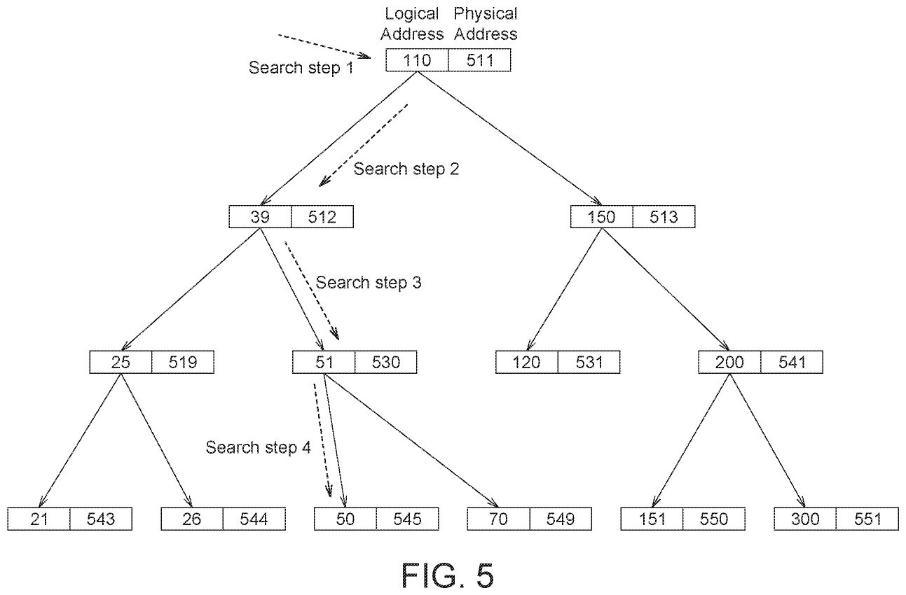

In an embodiment, the mapping table may be logically configured in a form of search tree, as shown in FIG. 5. The exemplary mapping table has four levels. In each of the levels, the logical address recorded in left branch is always smaller than the logical address recorded in the right branch. For example, the memory controller 104 intends to determine whether a target logical address of 50 is in the mapping table. In search step 1, the memory controller 104 determines whether 50 is in the first level of the mapping table, and obtains a result of “No”. In search step 2, the memory controller 104 compares 50 to the logical address recorded in the first level (i.e., 110), and determines to go to the left branch since 50 is smaller than 110. The memory controller 104 then checks whether 50 is in the left branch of the second level of the mapping table, and so forth. The memory controller 104 may finally find out that 50 is in the fourth level of the mapping table in search step 4. After searching, the memory controller 104 may read the target data from the physical address 545.

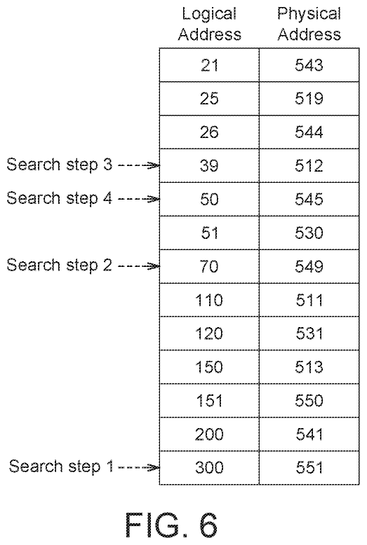

In another embodiment, the mapping table may be sorted according to the value of the logical address, as shown in FIG. 6. For example, the memory controller 104 intends to determine whether a target logical address of 50 is in the mapping table. Binary searching (e.g., search steps 1˜4) may be employed by the memory controller 104 for searching.

It should be noted that, the present invention is not limited to the searching approaches described above.

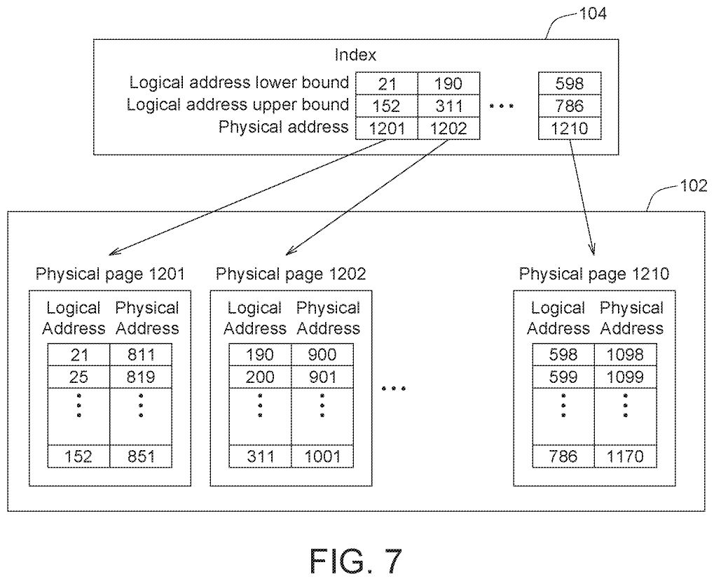

In an embodiment, the mapping table may be stored in a RAM of the memory controller 104. In another embodiment, while the mapping tables are too large to be stored in the RAM of the memory controller 104, the memory controller 104 may store the mapping tables into one or more pages of the memory 102, as shown in FIG. 7. Also, an index may be stored in the RAM of the memory controller 104. The index may record the pages of the memory 102 which store the mapping tables, and may also record the range (e.g., lower bound and upper bound) of the logical addresses Io stored in each of those pages.

In some embodiments, when the memory controller 104 cannot find the target logical address in the mapping table, the memory controller 104 may read the target data based on the target logical address and a preset writing rule. The preset writing rule is a rule for the memory controller 104 to follow when programming data into the memory 102. For example, if the preset writing rule defines that the physical address is (the logical address+32) and the host device sends data 0˜data 10 with a write command and a start address (logical address) of page 10 to the memory controller 104, the memory controller 104 may write data 0˜data 10 into the physical address 42˜52. That is, in this embodiment, the memory controller 104 should consider the preset writing rule when reading data from memory 102 for the correct target data.

The data storage device and operation method according to the present invention can efficiently manage the memory with defect by establishing the mapping table(s). When performing reading operation, the memory controller may search the mapping table(s) and find out the actual physical address of the target data, so that the data which are stored in defective pages may not be read. That is, the present invention can increase reliability of the data storage device.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A data storage device, comprising:
a memory, comprising a plurality of pages, each of the pages comprising a physical address; and
a memory controller, coupled to the memory, and configured to perform following operations:
receiving a plurality of data;
writing the plurality of data into a plurality of first pages of the memory;
verifying the plurality of data stored in the first pages of the memory;
writing the data which do not pass the verification into one or more second pages of the memory; and
establishing one or more mapping tables according to the physical address(es) of the first page(s) corresponding to the data which do not pass the verification and the physical address(es) of the second page(s).

2. The data storage device according to claim 1, wherein the memory is one time programmable.

3. The data storage device according to claim 1, wherein the one or more mapping tables record a map of logical address to physical address of the data stored in the memory.

4. The data storage device according to claim 1, wherein the memory controller is further configured to perform following operation:
receiving a target logical address; and
reading the data corresponding to the target logical address according to the target logical address and the one or more mapping tables.

5. The data storage device according to claim 4, wherein the operation of reading the data corresponding to the target logical address according to the target logical address and the one or more mapping tables comprising:
determining whether the target logical address is in the one or more mapping tables;
reading the data from the physical address corresponding to the target logical address according to the one or more mapping tables when the target logical address is in the one or more mapping tables; and
reading the data from the physical address according to the target logical address or according to the target logical address and a preset writing rule when the target logical address is not in the one or more mapping tables.

6. The data storage device according to claim 5, wherein the memory controller is configured to use binary searching or tree searching to determine whether the target logical address is in the one or more mapping tables.

7. The data storage device according to claim 1, wherein the one or more mapping tables are logically configured in a form of search tree.

8. The data storage device according to claim 1, wherein the one or more mapping tables are stored in the memory.

9. An operation method using data storage device, wherein the data storage device comprises a memory and a memory controller, the operation method is performed by the memory controller, and the operation method comprises:
receiving, by the memory controller, a plurality of data;
writing, by the memory controller, the plurality of data into a plurality of first pages of the memory;
verifying, by the memory controller, the plurality of data stored in the first pages of the memory;
writing, by the memory controller, the data which do not pass the verification into one or more second pages of the memory; and
establishing, by the memory controller, one or more mapping tables according to the physical address(es) of the first page(s) corresponding to the data which do not pass the verification and the physical address(es) of the second page(s).

10. The operation method according to claim 9, wherein the memory is one time programmable.

11. The operation method according to claim 9, wherein the one or more mapping tables record a map of logical address to physical address of the data stored in the memory.

12. The operation method according to claim 9, wherein the operation method is further comprises:
receiving, by the memory controller, a target logical address; and
reading, by the memory controller, the data corresponding to the target logical address according to the target logical address and the one or more mapping tables.

13. The operation method according to claim 12, wherein the step of reading the data corresponding to the target logical address according to the target logical address and the one or more mapping tables comprising:
determining, by the memory controller, whether the target logical address is in the one or more mapping tables; and
reading, by the memory controller, the data from the physical address corresponding to the target logical address according to the one or more mapping tables when the target logical address is in the one or more mapping tables; and
reading, by the memory controller, the data from the physical address according to the target logical address or according to the target logical address and a preset writing rule when the target logical address is not in the one or more mapping tables.

14. The operation method according to claim 13, wherein the memory controller is configured to use binary searching or tree searching to determine whether the target logical address is in the one or more mapping tables.

15. The operation method according to claim 9, wherein the one or more mapping tables are logically configured in a form of search tree.

16. The operation method according to claim 9, wherein the one or more mapping tables are stored in the memory.
